(19) United States
(12) Patent Application Publication
(10) Pub. No.: US 2008/0235133 A1
(43) Pub. Date: Sep. 25, 2008

(54) Native American Land Leasing

(76) Inventor: Tony Unwin, Orlando, FL (US)

Correspondence Address: FURR LAW FIRM, 2622 DEBOLT ROAD, UTICA, OH, 43080, US

(21) Appl. No.: 11/687,847

(22) Filed: Mar. 19, 2007

(51) Int. Cl. G06Q 40/00

(52) U.S. Cl. 705/39

(57) ABSTRACT

The present invention enables a tribe to bring in outsiders to build on its land and gain the benefits therein without losing the rights associated with the land. This enables tribes to expand their land use beyond casinos to create business parks, license banks, etc. Indian reservation can become high growth areas due to their low regulation and tax, becoming like Hong Kong and free trade zones.

### CROSS-REFERENCES TO RELATED APPLICATIONS (IF ANY)

None

### STATEMENT AS TO RIGHTS TO INVENTIONS MADE UNDER FEDERALLY-SPONSORED RESEARCH AND DEVELOPMENT (IF ANY)

None

### BACKGROUND OF INVENTION

1. Field of the Invention

The present invention is directed to a method of allowing land use of American Indian Land, more particular making long term lenses.

2. Background

Based on Native American law, the land rights of Native American Land and the rights of tribes are difficult to be passed on to non-Indians, or corporations. The difficulty lies in that non-Indians are seen as being non-Indian, and therefore do not enjoy the rights of Native Americans. If a tribe were to sell it's land (which is extremely difficult) the land would lose it's associated benefits. The question is how can a tribe bring in outsiders to build on it's land and gain the benefits therein without losing the rights associated with the land. How could a mortgage, or loan to build be granted given that a non-Indian builder cannot own the land.

There is still room for improvement in the art.

### SUMMARY OF THE INVENTION

The present invention is a system of master leases. The Tribe can grant long leases on the property (of up to 99 years). These leases can have a rolling/self renewing clause to make them function like freehold property. By granting a master lease to a developer the developer can further sub divide the land by issuing new leases, or sub leasing. Buildings can be financed on the structure alone as the underlying land would still be owned by the tribe, who may charge a ground rent for the property. This enables tribes to expand their land use beyond casinos to create business parks, license banks, etc.

The present invention enables a tribe to bring in outsiders to build on its land and gain the benefits therein without losing the rights associated with the land. This enables tribes to expand their land use beyond casinos to create business parks, license banks, etc. Indian reservation can become high growth areas due to their low regulation and tax, becoming like Hong Kong and free trade zones.

### BRIEF DESCRIPTION OF THE DRAWINGS

Without restricting the full scope of this invention, the preferred form of this invention is illustrated in the following drawings:

FIG. 1 is a schematic block diagram of a conceptualized operation of the present invention; and

FIG. 2 is a block diagram showing a basic arrangement of a computer system that can run the current invention.

### BRIEF DESCRIPTION OF THE PREFERRED EMBODIMENTS

There are a number of significant design features and improvements incorporated within the invention.

The present invention is a system of master leases. The Tribe can grant long leases on the property (of up to 99 years). These leases can have a rolling/self renewing clause to make them function like freehold property. By granting a master lease to a developer the developer can further sub divide the land by issuing new leases, or sub leasing. Buildings can be financed on the structure alone as the underlying land would still be owned by the tribe, who may charge a ground rent for the property. This enables tribes to expand their land use beyond casinos to create business parks, license banks, etc.

This invention enables a tribe to bring in outsiders to build on its land and gain the benefits therein without losing the rights associated with the land. This enables tribes to expand their land use beyond casinos to create business parks, license banks, etc. Indian reservation can become high growth areas due to their low regulation and tax, becoming like Hong Kong and free trade zones.

The current invention is a system 1 and method of allowing American Indian Tribes to grant land use excess to others.

The Tribe can grant long leases on the property (of up to 99 years). These leases can have a rolling/self renewing clause to make them function like freehold property. By granting a master lease to a developer the developer can further sub divide the land by issuing new leases, or sub leasing. Buildings can be financed on the structure alone as the underlying land would still be owned by the tribe, who may charge a ground rent for the property.

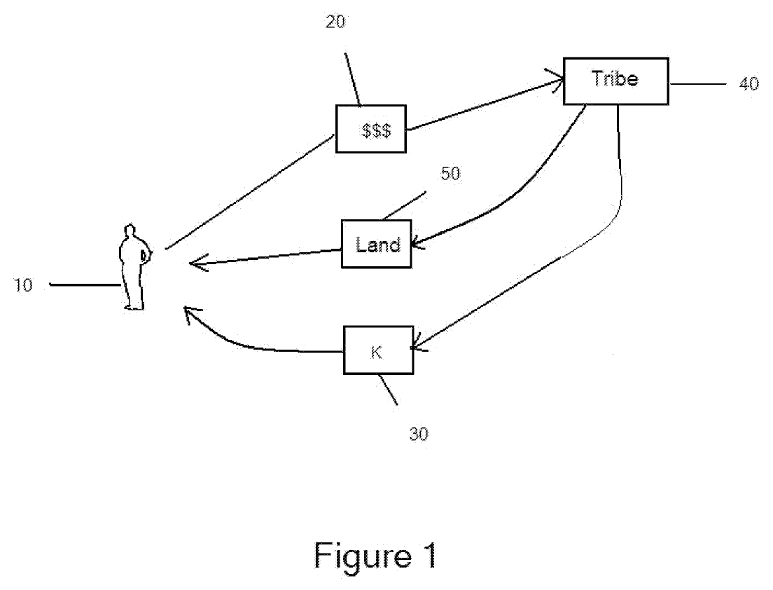

As shown in FIG. 1, a land user 10 would offer some type of consideration 20 such as money or other property for a long term lease 30 from an American Indian Tribe 40. The American Indian Tribe 40 would grant a long-term lease 30 for use of the land 40. The land user 10 would use the land 40. A land user 10 can also exchange stock or equity interest in a company that will control the lease 30.

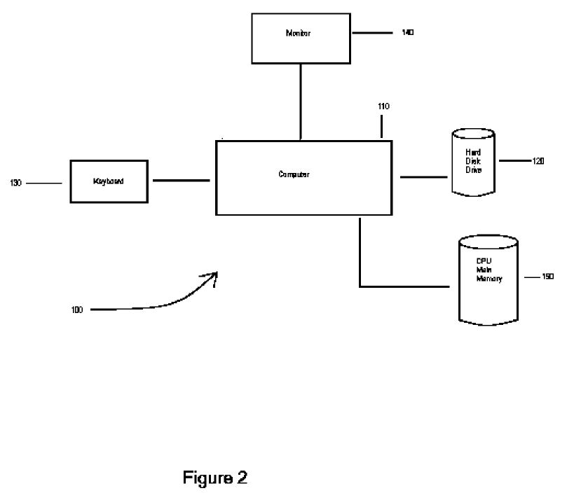

The system 1 can be set up to be run a on a computing device. FIG. 2 is a block diagram showing a computing device 100 on which the present invention can run comprising a CPU 110, Hard Disk Drive 120, Keyboard 130, Monitor 140, CPU Main Memory 150 and a portion of main memory where the program resides and executes. A printer can also be included. Any general purpose computer with an appropriate amount of storage space is suitable for this purpose. Computer Devices like this are well known in the art and is not pertinent to the invention.

The computer device 100 could be connected to other computer devices 100 through a communication interface such as the Internet, a wide area network (WAN), internetwork, telephone network or a private Value Added Network (VAN).

The storage and databases for the system may be implemented by a single data base structure at an appropriate site, or by a distributed data base structure that is distributed across an intra or an Internet network.

The files and file components discussed herein may be paper files, but in a preferred embodiment comprise data structures with electronic data. The setting up of the files and file structure is commonly known in the art and is not disclosed here.

It should be appreciated that many other similar configurations are within the abilities of one skilled in the art and all of these configurations could be used with the method of the present invention. Furthermore, it should be recognized that the computer system and network disclosed herein can be programmed and configured by one skilled in the art in a variety of different manners to implement the method steps described further herein.

### Advantages

This type of land leasing to non-native Americans is currently not used. Leasing to a corporation with American Indian ownership can make the business a Native American one. This method essential enables land to be re-zoned—from agricultural, to industrial, commercial, or whatever the highest and best use is. This method also allows for the creation of enterprise zone type areas—sections of land with low tax and regulation where business can flourish.

As to a further discussion of the manner of usage and operation of the present invention, the same should be apparent from the above description. Accordingly, no further discussion relating to the manner of usage and operation will be provided.

With respect to the above description, it is to be realized that the optimum dimensional relationships for the parts of the invention, to include variations in size, materials, shape, form, function and manner of operation, assembly and use, are deemed readily apparent and obvious to one skilled in the art, and all equivalent relationships to those illustrated in the drawings and described in the specification are intended to be encompassed by the present invention.

Therefore, the foregoing is considered as illustrative only of the principles of the invention. Further, since numerous modifications and changes will readily occur to those skilled in the art, it is not desired to limit the invention to the exact construction and operation shown and described, and accordingly, all suitable modifications and equivalents may be resorted to, falling within the scope of the invention.

I claim:

1. A method comprising the steps: having a user pay consideration to an American Indian Tribe and said American Indian Tribe giving a long-term lease for use of property.

2. The method as defined in claim 1, wherein said consideration is money.

3. The method as defined in claim 1, wherein said consideration is property.

4. The method as defined in claim 1, wherein said consideration is equity interest.

5. The method as defined in claim 4, where said equity interest is stock.

6. The method as defined in claim 4, where said equity interest is in the company receiving the lease.

7. The method as defined in claim 1, further comprising using a computer processor.

8. The method as defined in claim 1, further comprising said lease having a self renewing clause.
